(19) United States
(12) Patent Application Publication
(10) Pub. No.: US 2013/0038879 A1
(43) Pub. Date: Feb. 14, 2013

(54) MONITORING A SYSTEM USING OPTICAL REFLECTOMETRY

(71) Applicants: Christian Dorize, Nozay (FR); Gabriel Charlet, Nozay (FR); Patrice Tran, Nozay (FR)

(72) Inventors: Christian Dorize, Nozay (FR); Gabriel Charlet, Nozay (FR); Patrice Tran, Nozay (FR)

(21) Appl. No.: 13/580,302

(22) PCT Filed: Mar. 17, 2011
(86) PCT No.: PCT/EP11/54017

§ 371 Date: Sep. 20, 2012

(30) Foreign Application Priority Data
Mar. 31, 2010 (FR) 1052385

(51) Int. Cl. G01N 21/55

(52) U.S. Cl. 356/445

(57) ABSTRACT

A method for monitoring a system using optical reflectometry comprises:
receiving a first optical response signal coming from the system in response to a first optical excitation signal, said first excitation signal carrying a first numeric sequence (A),
receiving a second optical response signal coming from the system in response to a second optical excitation signal, said second excitation signal carrying a second numeric sequence (1A, B), and
determining correlations between said optical response signals and said numeric sequences in order to detect a singularity of the system. The first and second excitation signals are transmitted simultaneously within the optical system on separate carrier wavelengths λ₀, λ₁) by wavelength division multiplexing, and the first and second response signals are received simultaneously on said separate carrier wavelengths.

The invention pertains to the field of optical reflectometry measurements, in particular to measurements within which optical excitation signals carrying numeric sequences are transmitted within a system to be monitored in order to detect the system's singularities by correlating the excitation signals and the backscattered signals over time.

In optical systems, in particular telecommunication systems, singularities such as heterogeneities, discontinuities, ruptures, interfaces, and other refraction index variations may be located by optical reflectometry, as they influence the backscatter of optical signals. Measurement techniques known as optical time-domain reflectometry (OTDR) are founded on these phenomena. The purpose of an OTDR technique is to estimate the impulse response of a system to be monitored by sending an excitation signal into the system and measuring a backscattered response signal. The impulse response may be measured directly using an impulse excitation signal approaching a Dirac distribution δ. However, such an approach is subject to major limitations of power and signal-to-noise ratio. Alternatively, this measure may be estimated by sending a time-spread excitation signal s(t) featuring good autocorrelation properties, to with s(t) [symbol] s(t)≈δ(t) where [symbol] designates the correlation product. The use of Golay sequences in this context was described by WO-A-9720196.

According to one embodiment, the invention provides a method for monitoring a system by optical reflectometry, said method comprising the steps consisting of:

receiving a first optical response signal coming from the system in response to a first optical excitation signal, said first excitation signal carrying a first numeric sequence,
receiving a second optical response signal coming from the system in response to a second optical excitation signal, said second excitation signal carrying a second numeric sequence, and
determining correlations between said optical response signals and said numeric sequences in order to detect a singularity of said system, wherein the first and second excitation signals are transmitted simultaneously within the optical system at separate carrier wavelengths by wavelength division multiplexing (or WDM), and said first and second response signals are received simultaneously on said separate carrier wavelengths.

Such a method may be applied with multiple classes of numeric sequences for estimating with varying degrees of accuracy the impulse response of an optical response system, particularly pseudo-random binary sequences, bi-orthogonal sequences, wavelets, quadrature mirror filters, and bipolar and unipolar Golay codes. Golay codes are the most commonly used in optical reflectometry-based monitoring among sequences which exhibit the advantage of affording a practically perfect autocorrelation function, making it possible to very accurately measure the system's impulse response.

According to one advantageous embodiment, the first numeric sequence and second numeric sequence belong to a set of four unipolar sequences extracted from a pair of bipolar Golay sequences. According to another embodiment, the first numeric sequence and second numeric sequence constitute a pair of bipolar Golay sequences.

According to one embodiment, the first excitation signal successively carries a first plurality of numeric sequences, and the second excitation signal successively carries a second plurality of numeric sequences corresponding to one permutation of said first plurality of numeric sequences. Such a permutation of data in relation to the carrier wavelengths makes it possible to average out the physical effects depending on the wavelengths that may arise in the system to be monitored.

According to one embodiment, the first numeric sequence, or respectively the first plurality of numeric sequences, and a second numeric sequence, respectively the second plurality of numeric sequences, are mutually complementary. Such a property particularly makes it possible to regularize or equalize the total power of the optical excitation signals. Such a regularization is particularly beneficial in systems comprising optical amplifiers, because it makes it possible to limit temporary disturbances.

Such a method may serve to monitor systems of different types. According to one embodiment, the system comprises a long-range optical transmission line comprising EDFA amplifiers, for example an undersea transmission line.

Such a method may be implemented with any number of optical excitation signals. According to one embodiment, for excitation signals carrying the four unipolar sequences representing a pair of bipolar Golay sequences are simultaneously transmitted within the wavelength division multiplexing optical system, and four corresponding response signals are received simultaneously on separate carrier wavelengths.

According to one embodiment, the invention also provides an optical reflectometry monitoring apparatus, comprising:

a transmission device capable of being coupled to a system to be monitored in order to transmit within said system to be monitored a first excitation signal carrying a first numeric sequence and a second excitation signal carrying a second numeric sequence,
a reception device capable of being coupled to the system to be monitored in order to receive a first optical response signal coming from the system to monitor in response to the first optical excitation signal and a second optical response signal coming from the system to be monitored in response to the second optical excitation signal,
and a digital processing module capable of determining correlations between said optical response signals and said numeric sequences to detect a singularity of said system to be monitored,
within which the transmission device is capable of simultaneously transmitting the first and second excitation signals within the optical system along separate carrier wavelengths by wavelength division multiplexing, and the reception device is capable of simultaneously receiving said first and second response signals on said separate carrier wavelengths.

In other advantageous embodiments, such an apparatus may exhibit one or more of the following characteristics:
the transmission device comprises signal generators capable of respectively generating the first numeric sequence and the second numeric sequence and optical sources for respectively causing the first excitation signal and the second excitation signal on said separate carrier wavelengths.
the transmission device comprises a switch that reconfigurably connects the signal generators to the optical sources in order to modify the assignment of numeric sequences to carrier wavelengths.
the transmission device comprises a wavelength division multiplexer for combining the first optical excitation signal and the second optical excitation signal within a propagation medium.
the reception device comprises a wavelength division demultiplexer for separating the first response signal from the second response signal.
the reception device comprises first and second coherent optical receivers for receiving said first and second response signals on said separate carrier wavelengths.
the reception device comprises first and second coherent quadratic receivers for receiving said first and second response signals on said separate carrier wavelengths.
the reception device comprises a differential optical receiver to detect a difference between said first and second response signals on said separate carrier wavelengths.
the reception device comprises first and second storage modules for storing numeric response sequences obtained by respectively demodulating the first and second response signals.
the reception device comprises a switch that reconfigurably connects the optical receivers to the storage modules in order to modify the assignment of numeric sequences to carrier wavelengths.
a command module is provided to command the reception device's switch and the transmission device's switch matched up with one another, so that the first storage device exclusively receives the response signal corresponding to the first numeric sequence and the second storage module exclusively receives the response signal corresponding to the second numeric sequence.

Some aspects of the invention derive from the observation that there are circumstances under which it is necessary to obtain reflectometry measurements in as short a span of time as possible, for example when an OTDR technique is used to locate a fiber rupture in an optical communication system so that it can be repaired. Some aspects of the invention derive from the observation that determining the response of a long system by optical reflectometry may require acquiring and processing many and/or long digital sequences. Some aspects of the invention are founded on the idea of accelerating the acquisition of reflectometry measurements dealing with a system by simultaneously acquiring multiple back-scattering measurements in multiple intervals of the spectrum, for example on multiple channels of a WDM grid, preferably in intervals or on channels close to one another. Some aspects of the invention derive from the observation that the optical power injected into a system to acquire reflectometry measurements has a decisive influence on the signal-to-noise ratio of the detected signals. Some aspects of the invention are founded on the idea of distributing this optical power within multiple intervals of the spectrum in order to raise the power level from which the non-linear effects may disrupt the signals. Other aspects of the invention derive from the observation that the optical amplifiers that may be present within an optical system, particularly a long-range communication system, function optimally in the presence of a roughly constant load.

The invention will be better understood, and other purposes, details, characteristics, and advantages thereof will become more clearly apparent upon examining the following description of multiple particular embodiments of the invention, which are given only by way of illustrative and non-limiting examples, with reference to the attached drawings. In these drawings:

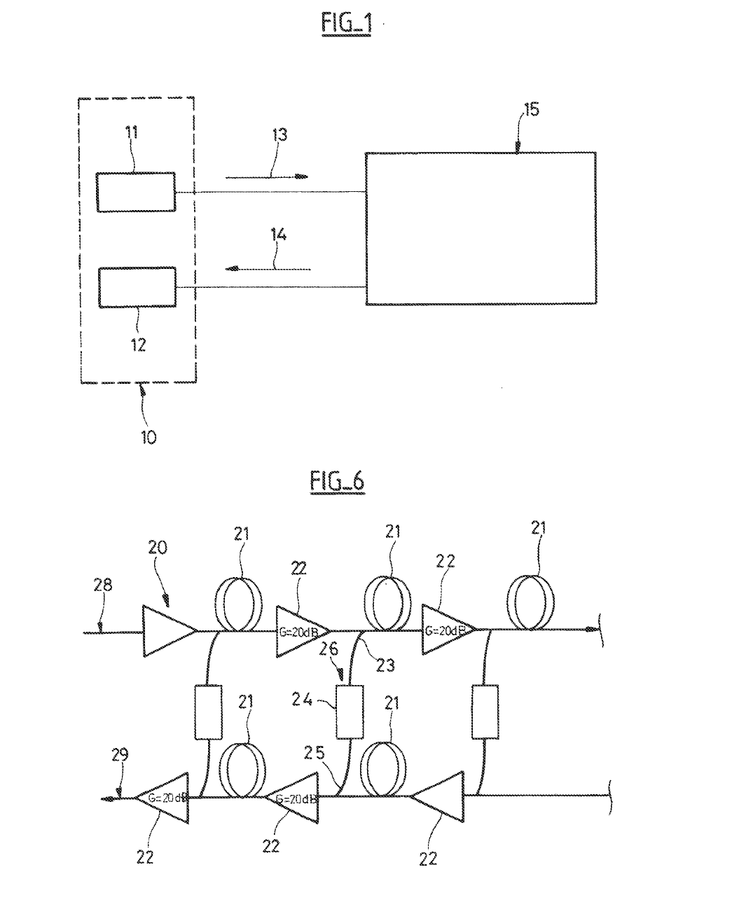

FIG. 1 is a functional schematic diagram of a measuring appliance according to one embodiment connected to an amplified optical transmission line.

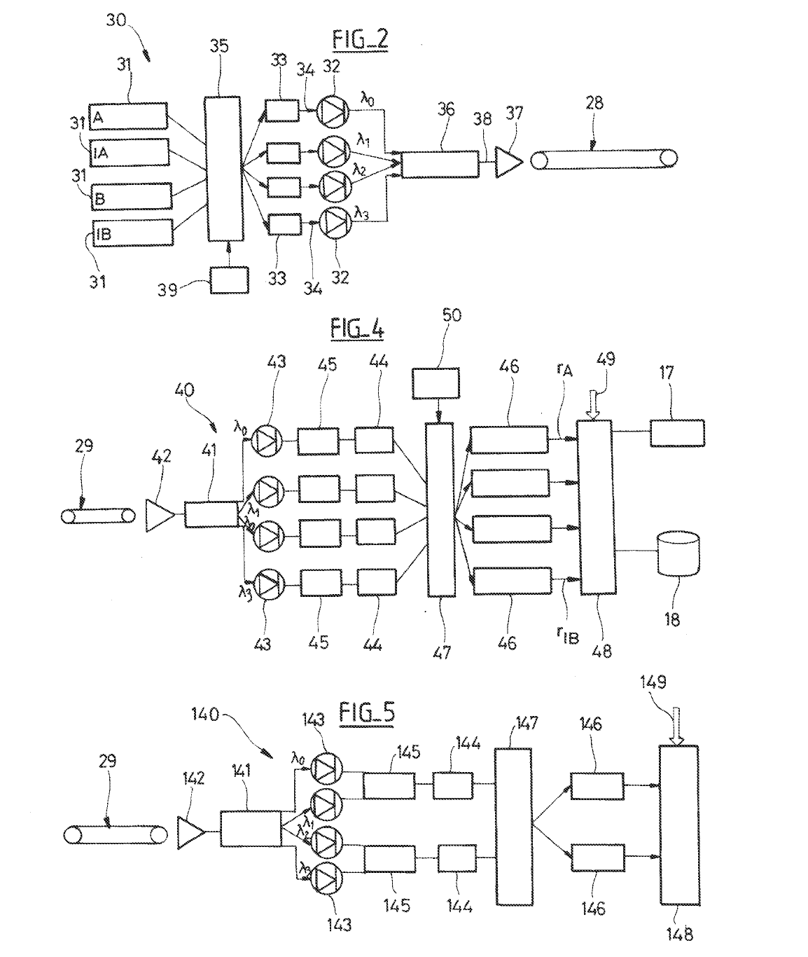

FIG. 2 is a functional schematic diagram of one embodiment of an excitation device that may be used within the appliance of FIG. 1.

FIG. 3 is a time-frequency diagram depicting the assignment of a plurality of numeric sequences to a plurality of carrier wavelengths that may be obtained with the device of FIG. 2.

FIG. 4 is a functional schematic diagram of one embodiment of a measurement device that may be used within the apparatus of FIG. 1.

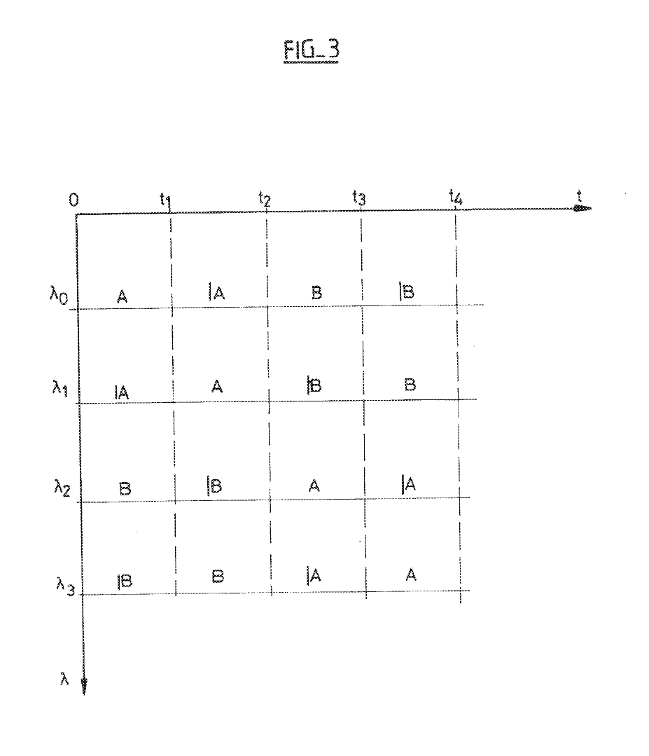

FIG. 5 is a functional schematic diagram of another embodiment of a measurement device that may be used within the apparatus of FIG. 1.

With reference to FIG. 1, an optical reflectometry measurement apparatus 10 is coupled to a system 15 within which measures must be acquired. The apparatus 10 comprises an excitation module 11 coupled to the system 15 in order to inject optical excitation signals into it on multiple wavelength channels, as indicated by the arrow 13, and a measurement module 12 coupled to the system 15 in order to receive back-scattered optical signals on the wavelength channels corresponding to the excitation signals, as indicated by the arrow 14. The coupling of the modules 11 and 12 to the system 15 may be constructed by power couplers or any other appropriate means, for example an optical circulator.

The system 15 may comprise any optical system, particularly an optical communication system such as a passive optical network or a portion of such a system. In the rest of the document, an embodiment is described in greater detail within which the system 15 is made up of a bidirectional amplified WDM transmission line 20 partially depicted in FIG. 6. The bidirectional line 20 may be used for very long range transmissions, such as for an undersea link of 1000 to 10,000 km or more.

The bidirectional line 20 comprises two unidirectional transmission lines 28 and 29, in opposite directions. Each of the lines 28 and 29 is schematically a succession of optical fiber segments 21 connected by optical amplifiers 22 in order to reamplify the transmitted signal, for example an EDFA signal. The distance between two successive amplifiers is, for example, between 50 and 100 km. To create a return path for the back-scattered signals, optical bridges 26 are arranged between the two lines 28 and 29, using the known technique. In the example depicted, an optical bridge 26 comprises a power coupler 23 for taking the back-scattered signal from the line 28 and a power coupler 25 to re-inject that signal within the line 29, as well as an optical attenuator 24 arranged between these power couplers. Similar bridges may also be provided in the reverse direction. The transmission line 20 may comprise many other elements that are not depicted, such as chromatic dispersion compensators, using the known technique of WDM optical transmissions.

In one embodiment, the excitation module 11 comprises an excitation device 30 depicted in FIG. 2. The device 30 comprises signal generators 31 for generating numeric sequences suitable for time-domain reflectometry measurements, optical sources 32 for generating optical signals modulated over separate carrier wavelengths λ0 to λ3 and digital-analog converters 33 that each time supply a source 32 with a baseband signal 34 produced from the numeric sequence of a generator 31. An electronic switch 35 is arranged between the signal generators 31 and the converters 33 in order to be able to modify the assignments of the numeric sequences to the carrier wavelengths. A command module 39 is used to command the switch 35, for example based on the control program loaded into memory that is not depicted, or based on orders provided from a human-machine interface that is not depicted. The optical sources 32 are connected to a multiplexer 36 in order to combine the modulated optical signals within a waveguide 38, which is connected to the transmission line 28 by means of an optical amplifier 37.

In one embodiment, the signal generators 31 respectively each produce four unipolar components A, |A, B, and |B making it possible to reconstruct a pair of bipolar Golay sequences (GA, GB), i.e.: A=½(1+GA); |A=½(1−GA); B=½(1+GB); |B=½(1−GB)

The sequences A and |A, or respectively B and |B, are said to be complementary in the sense that their sum is a constant-value signal. For example, the length of the sequences may be about 2² to 2¹⁵ bits.

When operating, the device 30 therefore makes it possible to simultaneously transmit the four unipolar sequences over the four carrier wavelengths λ0 to λ3. These optical excitation signals are, for example, amplitude-modulated by an NRZ code at a rate of about 100 kHz. Some advantages of such a simultaneous transmission are generating a roughly constant optical power for the amplifiers 22 of the line 20, and to make it possible to simultaneously acquire the responses from the line 20 corresponding to the various unipolar sequences. This point will now be illustrated with reference to FIG. 4.

In one embodiment, the measurement module 12 comprises a measurement device 40 depicted in FIG. 4. The device 40 comprises a wavelength demultiplexer 41 connected to the transmission line 29, for example by means of an optical amplifier 42, in order to receive the response signals back-scattered by the line 20 in response to the excitation signals transmitted by the excitation device 30. The response signals are normally at the same wavelength as the excitation signals. The outputs of the wavelength multiplexer 41 are respectively connected to optical detectors 43, for example photodiodes. The demultiplexer 41 makes it possible to separate the response signals on each of the carrier wavelengths λ0 to λ3 and to pass through respective detectors to detect them separately. Each detector 43 is connected to an analog-digital converter 44, such as by means of an electronic amplifier 45. Each analog-digital converter 44 makes it possible to supply a buffer memory 46, such as a FIFO memory, with a signal resulting from sampling the response signal on the corresponding wavelength. An electronic switch 47 is arranged between the convertors 44 and the buffer memories 46 in order to be able to modify the assignments of response signals to the buffer memories 46. A command module 50 is used to command the switch 47, for example based on the control program loaded into memory that is not depicted, or based on orders provided from a human-machine interface that is not depicted.

A calculator 48 makes temporal calculation correlations between the sampled response signals and the initially transmitted numeric sequences in order to determine the impulse response of the system 15 being studied and/or locate singularities, for example a rupture zone of the transmission line 20. To do so, the calculator 48 is connected to the signal generators 31 in order to receive numeric sequences, as indicated by the arrow 49, as well as buffer memories 46 in order to access the response signals r_{A}, r_{|A}, r_{B}, and r_{|B}. In FIG. 4, r_{A} is said to be the response signal corresponding to the excitation signal carrying sequence A. The mathematical bases of these calculations are described in “Real-time Long Range Complementary Correlation optical Time Domain Reflectometer”, M. Nazarathy et al., Journal of Lightwave Technology, Vol. 7, No 1, January 1989.

These calculations are preferably carried out during the acquisition of response signals, in particular when the signals' acquisition duration is long. For example, an acquisition duration lasting several days may be necessary to estimate the impulse response of an undersea transmission line with a satisfactory signal-to-noise ratio. However, the simultaneous use of multiple wavelength channels to acquire multiple response signals makes it possible to improve the signal-to-noise ratio of a factor √N, where N designates the number of signals acquired simultaneously, in relation to a measurement founded on a single excitation signal during that same duration. In FIG. 4 where N=4, a gain of 3 dB is therefore obtained in the signal-to-noise ratio. This use of wavelength division multiplexing in optical reflectometry therefore produces an improvement in the ratio between the convergence duration of a detection and its accuracy.

The calculator 48 may comprise various peripherals 17, such as a monitor, printer, and/or communication module in order to show calculation results to users in an appropriate form, such as numeric, text-based, or graphic. A storage device 18 may also be provided for recording these results.

In one embodiment in which devices 30 and 40 are both included in the apparatus 10, the command modules 39 and 50 may be merged together. In particular, the switches 35 and 47 may be switched to match one another during the acquisition of a reflectometry measurement in order to organize a permutation of different numeric sequences at different carrier wavelengths. Such a permutation is depicted in FIG. 3.

FIG. 3 represents the various numeric sequences transmitted on various carrier wavelengths, on a timescale corresponding to a campaign of monitoring the line 20 with the help of one embodiment of the apparatus 10. The numeric sequences are permutated during the acquisition of the reflectometry measurements at moments t₁, t₂, t₃, t₄, etc., for example periodically. Depending on the attenuation level of the signals in the tested system and the length of the numeric sequences used, it may be necessary to cyclically repeat a large number of successive measurements according to this scheme in order to obtain a usable signal to noise ratio. In this permutation scheme, all the sequences are transmitted simultaneously with the complementary sequence, which makes it possible to obtain an amplifier 22 load that is roughly invariant. Other permutation schemes make it possible to achieve a similar result.

Other means besides the switches 35 and 47 may be provided to carry out our permutation of numeric sequences on different carrier wavelengths. Such a permutation makes it possible to distribute the physical distortions that depend on the wavelengths across the various numeric sequences, in order to smooth out their effect. However, this permutation is not essential. In one embodiment, the entire measurement campaign may be performed with the assignment of sequences represented between the times 0 and t₁.

Furthermore, the use of for wavelength channels indicated on FIGS. 2 to 4 is for illustrative purposes. In other embodiments, a lower or greater number of channels may be used to inject excitation signals and acquire response signals. Furthermore, the lines λ0 and λ1 alone in FIG. 3 illustrate a way of proceeding with two channels.

The position of the wavelength channels simultaneously use within the spectrum may be any position. However, the impulse response measurement of the system obtained in this manner represents an average in relation to the spectral interval covered by the excitation signals. This measurement may therefore be disrupted by the sensitivity of some of the system's properties to wavelengths, such as chromatic dispersion. It may therefore be preferable to choose relatively close-together wavelength channels, such as adjacent channels on a standard grid based 50 or 100 GHz apart, in order to limit these disruptions and obtain more significant measurements within a spectral bands in which the physical behavior of the fiber features little variation. The effective chromatic dispersion, however, is limited if the excitation signals' modulation rate remains moderate, for example about 100 kb/s.

FIG. 5 depicts another embodiment of the measurement device 140 that may be used as a measurement module 12. Elements identical or similar to those in FIG. 4 are designated by the same reference figures, plus 100. Here, the response signals detected in the wavelengths λ0 and λ1 and respectively λ2 and λ3 are entered into a differential amplifier 145 that produces a deviation signal. Thus, if the sequence A is transmitted on λ0 and the sequence |A on λ1, or respectively B on λ2 and |B on λ3, this deviation signal directly represents the system's response to the bipolar sequence GA, or respectively GB, and may be processed as such in the remainder of the signal processing. The result is hardware savings within the converters 144 and memories 146.

In one variant, coherent optical receivers may be used in the measurement module 12.

Although the embodiments above make reference to Golay sequences, other numeric sequences, for example Quadrature Mirror Filters (QMF) or orthogonal wavelets offer the similar property of making it possible to practically perfectly reconstruct the system's impulse response and may be used the same way to produce excitation signals.

Some of the elements depicted, particularly the command modules and the digital processing modules, may be constructed in various forms, in a stand-alone or distributed fashion, using hardware and/or software components. Hardware components that may be used are application-specific integrated circuits, field-programmable gate arrays, or microprocessors. Software components may be written in various programming languages, such as C, C++, Java, or VHDL. This list is not exhaustive.

Although the invention has been described in connection with multiple specific embodiments, it is naturally not in any way limited to them, and comprises all technical equivalents of the means described, as well as their combinations, if said combinations fall within the scope of the invention.

The use of the verb “comprise” or “include” and their conjugated forms does not exclude the presence of elements or steps other than those set forth in a claim. The use of the indefinite article “a” or “an” for an element or step does not, unless otherwise stated, excluded the presence of a plurality of such elements or steps. Multiple means or modules may be depicted by a single hardware element.

In the claims, any reference sign within parentheses should not be interpreted as limiting the claim.

1. A method for monitoring a system (15, 20) using optical reflectometry, said method comprising the steps of:
receiving a first optical response signal coming from the system in response to a first optical excitation signal, said first excitation signal carrying a first numeric sequence (A);
receiving a second optical response signal coming from the system in response to a second optical excitation signal, said second excitation signal carrying a second numeric sequence (1A, 13); and
determining correlations between said optical response signals and said numeric sequences in order to detect a singularity of said system;
wherein the first and second excitation signals are transmitted simultaneously within the optical system on separate carrier wavelengths (I₀, I₁) by wavelength division multiplexing, and the first and second response signals are received simultaneously on said separate carrier wavelengths.

2. A method according to claim 1, wherein the first numeric sequence (A) and the second numeric sequence (|A, B) the long to a set of four unipolar sequences extracted from a pair of bipolar Golay sequences.

3. A method according to claim 1, wherein the first excitation signal successively carries a first plurality of numeric sequences (A, B, |A, |B) and the second excitation signal successively carries a second plurality of numeric sequences corresponding to one permutation of said first plurality of numeric sequences.

4. A method according to claim 3, wherein the first numeric sequence, or respectively the first plurality of numeric sequences, and the second numeric sequence, or respectively the second plurality of numeric sequences, are mutually complementary.

5. A method according to claim 1, wherein said system comprises an optical transmission line (20) comprising EDFA amplifiers (22).

6. A method according to claim 1, wherein for excitation signals carrying four unipolar sequences representing a pair of bipolar Golay sequences are transmitted simultaneously within the optical system by wavelength division multiplexing and four corresponding response signals are simultaneously received on separate carrier wavelengths (λ₀, λ₁, λ₂, λ₃).

7. An optical reflectometry monitoring apparatus (10) comprising:
a transmission device (11, 30) operatively coupled to a system to be monitored (15, 20) in order to transmit within said system to be monitored a first excitation signal carrying a first numeric sequence and a second excitation signal carrying a second numeric sequence;
a reception device (12, 40, 140) operatively coupled to the system to be monitored in order to receive a first optical response signal coming from the system to monitor in response to the first optical excitation signal and a second optical response signal coming from the system to be monitored in response to the second optical excitation signal;
and a digital processing module (48, 148) for determining correlations between said optical response signals and said numeric sequences to detect a singularity of said system to be monitored;
within which the transmission device simultaneously transmits the first and second excitation signals within the optical system along separate carrier wavelengths (λ₀, λ₁) by wavelength division multiplexing; and
the reception device simultaneously receives said first and second response signals on said separate carrier wavelengths.

8. An apparatus according to claim 7, wherein the transmission device further comprises:
signal generators (31) for generating the first numeric sequence and the second numeric sequence;
optical sources (32) for respectively causing the first excitation signal and the second excitation signal on said separate carrier wavelengths; and
a switch (35) that reconfigurably connects the signal generators to the optical sources in order to modify the assignment of numeric sequences to carrier wavelengths.

9. An apparatus according to claim 7, wherein the transmission device further comprises a wavelength division multiplexer (36) for combining the first optical excitation signal and the second optical excitation signal within a propagation medium.

10. An apparatus according to one of the claim 7, wherein the reception device (40, 140) further comprises a wavelength demultiplexer (41, 141) for separating the first response signal from the second response signal.

11. An apparatus according to claim 7, wherein the reception device further comprises:
first and second coherent quadratic receivers (43, 143) for receiving said first and second response signals on said separate carrier wavelengths;
first and second storage modules (46, 146) for storing the first and second response signals; and
a switch (47, 147) that reconfigurably connects the optical receivers to the storage modules in order to modify the assignment of response signals to storage modules.

12. An apparatus according to claim 11, further comprising:
a command module (50, 39) for commanding the reception device's switch and the transmission device's switch matched up with one another, so that the first storage device exclusively receives the response signal corresponding to the first numeric sequence and the second storage module exclusively receives the response signal corresponding to the second numeric sequence.
